(19) United States
(12) Patent Application Publication
(10) Pub. No.: US 2005/0078391 A1
(43) Pub. Date: Apr. 14, 2005

(54) Self-cleaning window structure

(76) Inventor: Sadeg M. Faris, Pleasantville, NY (US)

Correspondence Address: REVEO, INC., 3 WESTCHESTER PLAZA, ELMSFORD, NY, 10523, US

(21) Appl. No.: 10/962,990

(22) Filed: Oct. 12, 2004

Related U.S. Application Data
(60) Provisional application No. 60/510,371, filed on Oct. 10, 2003.

(51) Int. Cl. G02B 5/00

(52) U.S. Cl. 359/894; 359/896

(57) ABSTRACT

A self-cleaning transparent structure is described herein having dust resistant qualities and improved optical qualities. A transparent surface is provided with randomly positioned protrusions attached to a transparent surface. The protrusions act upon particles that settle on the protrusions, by diminishing the particles surface adhesion. Furthermore, the transparent features of the transparent surface are no diminished, since the period between each protrusion is less than the wavelength of visible light.

### CROSS-REFERENCE TO RELATED APPLICATIONS

The present application claims priority to U.S. Provisional Application No. 60/510,371 filed on Oct. 10, 1003 entitled “Self Cleaning Window Structure” which is herein incorporated by reference.

### BACKGROUND

As commonly known maintaining glass or windows can be an arduous and costly undertaking. Although structures (i.e. buildings) with few windows rarely encounter this quandary, it does pose an immense problem for structures (i.e. buildings, greenhouses) with many windows. Moreover, as building heights increase the numbers of windows increase. Consequently, the cost of maintaining these windows increases. Also, adding to the rising cost of maintaining windows are various safety measures and procedures, which must be implemented in order to safeguard the wellbeing of those brave individuals who endeavor to maintain the scores of windows on these vast structures.

Furthermore, because the sources that soil the windows vary the application of a universal method or cleaning solution does not always achieve the desired result. For instance a cleaning solution or method applicable to dusk may not be applicable to acid rain. Also problematic is the storage of glass in humid environments, which can lead to water droplets forming on the glass during storage, thereby, causing the leaching of alkaline material from the glass.

Presently many techniques or chemical processes are utilized in order to overcome this predicament and to allow glass to maintain a spotless and pristine appearance. One such process utilizes photocatalytic metal oxides to coat the surface of the structure; however, this process is most proficient in eradicating biological matter. Consequently, its effect on non-biological matter is doubtful and uncertain.

Another technique coats the glass with a silica-based coating, for example, U.S. Pat. No. 5,424,130 (Nakanishi, et al., the teachings of which are incorporated herein by reference). The silica-based material causes water to bead up once it touches the surface of the coated glass. Although this process would avert the aforementioned difficulty such as alkaline leaching, it is must suitable for environments with an abundant airstream. Accordingly, this process would have limited application and success in environments of little or no airstream.

Another technique produces the self-cleaning effect via elevations and depressions of the surface of the structure, for example U.S. Ser. No. 10/120,366 (Nun, et al., the teachings of which are incorporated herein by reference). Although, the aforementioned technique produces a self-cleaning effect it however, has limited optical quality. Consequently, the use of this technique is limited to surfaces where transparency is not a concern. The aforementioned technique teaches that its self-cleaning surface can be made transparent to the extent that only sunlight can penetrate the surface. Consequently, the aforementioned invention has limited optical quality and would not be suitable where optical quality is a necessity (i.e. windows, winds shields).

Presently, all the aforementioned approaches to self-cleaning glass consist of utilizes a coating material to attain the ability of limiting or thwarting soiled glass. Although these approaches achieve various degrees of success there are inherent disadvantage with each. The first is the appearance of coloration in the glass due to light, which is ever present when elevated structures are positioned on a transparent structure. Another disadvantage is the lack of random placement of the elevated structures, which contribute to coloration, because, as ambient light strikes the glass surface the light cannot scatter.

Although several processes address de-coloration, the processes are accomplished by chemical means, which add addition time and expense to the manufacturing process. Moreover, many of the coating techniques have little resistances to abrasion. Consequently, given certain environments and time the self-cleaning characteristics will cease.

The solution to this dilemma was found in nature. The Lotus plant or flower is well known as having self-cleaning leaves.¹ Its discovery by Wilhelm Barthlott of the University of Bonn in Germany led to attempts to harness this naturally occurring phenomenon in the fields of paint, and on certain hard surfaces. The lotus plant is unique because the leaves have very small bumps on the surface. Consequently, the surface of the leaves are rough in comparison to other plant leaves. This roughness gives the Lotus Plant hydrophobic characteristics. The hydrophobic characteristic is primarily due to a reduced contact area between the water and leaf. As water droplets settle on the leaves of the Lotus Plant the bumps reduce the contact area to only 2-3%. Moreover, at certain contact angles the droplets roll-off, and wash away any dust particle the droplets encounters, thereby producing a self-cleaning effect. The result is the Lotus Plant will stay clean and dry even during torrential down pours.
¹ See, e.g., ScienceWorld, January 2000, Hans Christian Von Baeyer, “The secret of the self-cleaning leaves of the lotus plant, like the subtlest applications of high technology, is simplicity itself”, which is incorporated by reference herein.

For the foregoing reasons, there is a need for a self-cleaning window structure that is transparent and is not subject to coloration, diminished optical quality and erosion and that can be inexpensively manufactured.

### SUMMARY

The present invention is directed to a self-cleaning transparent structure, which satisfies the need for a dust resistant glass surface, which can maintain sufficient optical quality. The transparent structure comprises a glass surface with a plurality of spaced apart protrusions, each protrusion having a distal end and an end protruding from the base level of the glass surface; wherein the protrusions are configured and positioned upon the base level to minimize deviation from transparency.

### DESCRIPTION OF THE DRAWING

These and other features, aspects, and advantages of the present invention will become better understood with regards to the following description, appended claims, and accompanying drawings where:

FIG. 1 shows an enlarged view of a transparent surface;

FIG. 2 shows an enlarged view of the protrusions of a transparent surface,

FIG. 3 shows a transparent structure with randomly placed protrusions,

FIG. 4 shows a float glass manufacturing facility; and

FIG. 5 shows a vacuum device used for protruding protrusions.

### DESCRIPTION OF THE INVENTION

The present invention herein provides a dust resistant transparent surface with self-cleaning qualities, wherein protrusions extend therefrom.

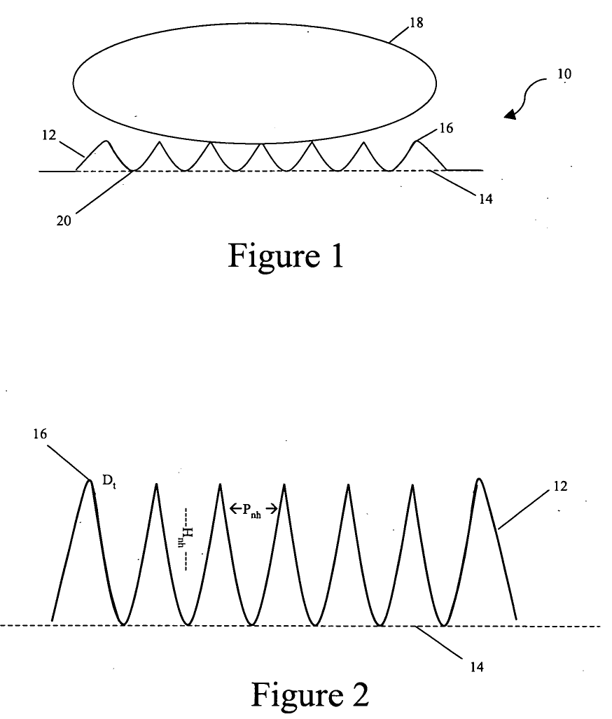

Referring to FIG. 1, an enlarged portion of a transparent surface 10 is shown. Extending from the transparent surface 10 are protrusions 12. The protrusions 12 are connected to the transparent surface 10 via the base level 14. The protrusions can be integral with the base level 14 or adhered to the base level 14. The base level 14 is the region of the transparent surface 10 where the protrusions 12 start and the transparent surface 10 terminates. Located at the apex of each protrusion 12 is a distal or a terminal end 16. In addition in certain embodiments the distal end 16 of each protrusion 12 may have a roll-off angle of about 1 degree to about 10 degrees. Positioned on top of the distal end 16 can be one or more particles 18. Consequently, during the particle resistance phase, a particle 18 settles on one or more protrusions 12, the particle 18 is acted upon by the protrusions 12, thereby limiting particles surface adhesion and precluding particle 18 bonding.

Furthermore where optical transparency or certain other optical qualities are desired, the positioning and configuration of the protrusions may be altered depending of the optical quality needed. For example in the preferred embodiment where transparency is desired, the protrusions are positioned in a non-pattern or random configuration. In another embodiment where limited transparency is required the protrusions are positioned in a semi-patterned configuration. In yet another embodiment where an image, design or opaqueness is required the protrusions are positioned in such a way that the design, image or opaqueness is produced.

As compared to the transparent surface 10 the protrusions 12 are elevated, accordingly, the spatial areas 20 between the protrusions 12 can be a planar or a chasm configuration. Furthermore, the distance between each protrusion 12 is such that the optical effect of Bragg's Law is reduced or eliminated. It is understood that the spatial areas 20 between the protrusions 12 are not limited to a planar or a chasm configuration, and can be any suitable horizontal expression. For purposes of illustration the protrusions 12 appear conical, however, the protrusions 12 are not limited to a conical configuration. Consequently, the protrusions can be circular, ciliated and rod shaped. Furthermore, to enhance the dust resistant qualities of the transparent surface 10, the protrusions 12 can be made of or finished with a hydrophobic material.

Accordingly, when the transparent surface 10 is exposed to dust or other particles 18, the surface area where contact lies is extremely small, as the particles 18 only contact the protrusions 12. Further, due to the small diameter of the distal ends 16 of the protrusions 12, the contact angle between the protrusions 12 and the particle 18 is very large. Thus, adhesion of the particles 18 is minimized or eliminated, and miniscule agitations cause any droplets to traverse the transparent surface 10.

In a preferred embodiment the transparent surface 10 comprises glass. Producing the protrusions 12 on the surface of glass is simple and cost effective, due to the transparent nature and composition of glass and, its ability to be shaped and molded.

In another preferred embodiment the transparent surface 10 comprises plastic material. Suitable plastic substrates include synthetic organic polymeric substrates, for example, acrylic polymers, polyesters, polyamides, polyimides, acrylonitrile-styrene copolymers, styrene-acrylonitrile-butadiene tertpolymers, polyvinyl chloride, butarates, polyethylene and the like. A particular substrate that may benefit from the present invention and enjoys widespread use is polycarbonate, such as Lexan® commercially available from General Electric Company. Further, the substrate may be substantially rigid, or in certain embodiments flexible substrates may benefit from the coating layer of the present invention.

It is understood that the material used to fabricate the transparent surface is not limited to glass, plastic or polycarbonate material and can be any suitable transparent material which does not have limited transparency or diminished optical quality upon implementation of the protrusions 12.

Referring to FIG. 2, shown is an enlarged view of the protrusions 12. As previously mentioned the apex of each protrusion 12 has a distal end 16, where the diameter is shown as Dₜ. Furthermore, the height from the base surface 14 of the transparent surface 10 to the distal end 16 is shown as Hₙₕ and the period between each protrusion 12 is Pₙₕ.

In a preferred embodiment, the diameter of the distal end 16 is substantially less than 0.5 μm, which is the average diameter of a particle of dust. Preferably, the diameter of the distal end Dₜ is such that the contact area of a particle (e.g., dust) atop plural protrusions is less than 2%, as in the Lotus plant. Consequently, protrusions 12 which are substantially less than 0.5 μm will prevent a particle 18 from bonding to a single protrusion 12. In addition, the height of the protrusions 12 may be on the order of about 5 μm to 10 μm, which is the height of the bumps located on the cuticle of the lotus plant. In certain embodiments, the ratio of Hₙₕ/Dₜ is at least 20. However, the ratio of Hₙₕ/Dₜ may be any ratio suitable for limiting surface adhesion.

In another preferred embodiment, the period between each protrusion 12 is sized in order to minimize or eliminate optical deviations caused by well known Bragg's Law diffraction.

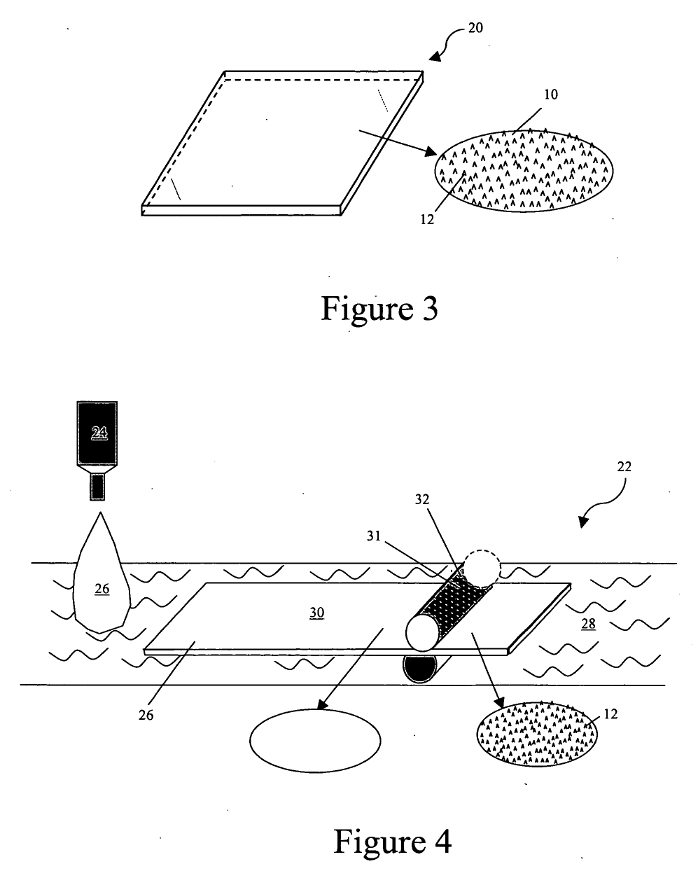

Referring to FIG. 3, shown is a magnified view of a transparent surface 10 of a transparent structure 20. Further illustrated are protrusions 12, which are, in preferred embodiments, positioned in a non-pattern or random configuration. The protrusions 12 are arranged in a non-pattern or random configuration in order to preclude coloration and optical distortion.

As mentioned before the protrusions 12 can be integral to the transparent surface 10 or adhered to the transparent surface 10. In order to apply the protrusions 12 to the transparent surface 10, various manufacturing methods can be implemented. In one embodiment the transparent surface 10 is set and maintained at a temperature suitable for processing. Next the protrusions 12 are formed on the transparent surface 10, where the protrusions 12 will extend from the base level 14.

Referring to FIG. 4, shown is a float glass manufacturing system. The float glass manufacturing system 22 is another example of a manufacturing method to form protrusions 12 onto the transparent surface 30. Under this method a raw material dispenser 24, dispenses raw float glass 26 into a fluid course 28. The float glass 26 is then floated on the fluid course 28 of molten indium or tin; furthermore do to its properties the glass will not interact with the indium or tin. As the float glass 26 floats down the fluid course 28, various procedures and apparatus act upon the float glass 26, thereby given the float glass 26 it's chosen configuration. Next one or more surfaces 30 of the float glass structure 26 is maintained in a continuous or segmented soft molten state (e.g., about 1000 deg. C.). Subsequently, the protrusions 12 are formed on the glass surface 30 while the glass surface 30 is in a molten state. It is understood that the fluid course 28 is not limited to indium or tin, but can be any substrate capable of maintaining the float glass 26 in a molten state, without reacting with the float glass 26.

Another embodiment uses the method of embossing to form the protrusions 12. During embossing one or more surfaces 30 of a float glass structure 26 is maintained in a continuous or segmented soft molten state. Next, the float glass structure 26 is directed through a pair of rollers 32 in line of the float glass assembly. Embossing features 31 are positioned on one of the aforementioned rollers (or both if dual surfaces 30 are desired). As the float glass structure 26 emerges from the rollers 32, the protrusions 12 have been embossed onto the surface 30 of the float glass structure 26.

In another embodiment the process of stamping forms the protrusions 12. While the float glass structure is in the continuous or segmented soft molten state, the protrusions are stamped onto the surface 30 of the float glass structure 26.

In yet another embodiment the process of brushing forms the protrusions 12. While the float glass structure is in the continuous or segmented soft molten state, the protrusions 12 are brushed onto the surface 30 of float glass structure 26, via bristles.

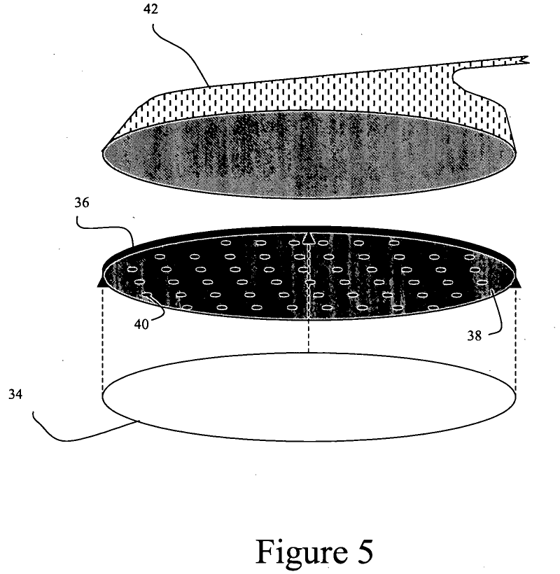

Referring to FIG. 5, shown is a vacuum device, for producing protrusions on the surface of a float glass structure. In this embodiment a vacuum device is used to form the protrusions 12 on the glass surface 34, while the glass surface is in a continuous or molten state. For example a method of making a suitable vacuum device is describes in U.S. Ser. No. 10/017,186, entitled “Device For Handling Fragile Objects”, which describes a handler for use in semi-conductor processing, herein incorporated by reference. This apparatus includes a suction force or a vacuum 42 and a handler 36, for a fragile object (i.e. glass surface) that possesses sufficient rigidity and strength to withstand potentially rough mechanical handling, and also capable of serving as a substrate for a transparent structure. The suction force or vacuum 42 is attached to a handler 36. The handler 36 includes a front surface 38. The handler 36 is capable of subjecting objects (i.e. glass surface) of extreme fragility to the suction force 42. The front surface 38 possess a plurality of holes 40, which break the front surface 38 in a designated pattern. For purposes of illustration the plurality of holes 40 are shown has patterned. However, it is understood that the plurality of holes 40 are not limited to this configurations and can be any configuration suitable to produce protrusions, which have self-cleaning characteristics and optimal transparent capability. These holes form a low air resistance vacuum passage for a well-distributed suction force or vacuum 42 to be applied to the glass surface 34. Consequently, the suction force 42 pulls on the molten glass surface 34, thereby producing the protrusions. It is understood that the vacuum is not limited to an oval shape and can be any shape suitable to produce a suction force capable of creating protrusions.

In all of the above examples, when the glass cools, the protrusions remain on the surface of the float glass structure. Furthermore it is understood that protrusion production can be preformed by all conventional float glass manufacturing process and/or techniques.

Although self-cleaning structures or processes are well known, they are limited as to optical quality. Accordingly, the above described invention overcomes this defect with a unique approach to protrusion positioning. The present invention positions the protrusions on the surface of the structure in such a way that optical quality is not affected. The present invention randomly, places the protrusions, thereby allowing light to scatter once the light strikes the structure, however, the protrusion can also be positioned to limit optical quality if so desired. Consequently, the present invention achieves the self-cleaning affect without losing optical quality.

While preferred embodiments have been shown and described, various modifications and substitutions may be made thereto without departing from the spirit and scope of the invention. Accordingly, it is to be understood that the present invention has been described by way of illustrations and not limitation.

1. A transparent structure having at least one dust resistant surface, the transparent structure comprising:
a surface including a base level, and
a plurality of spaced apart protrusions, each protrusion having a distal end and an end protruding from the base level;
wherein the protrusion are configured and positioned upon the base level to minimize deviation from transparency.

2. The transparent structure has in claim 1, wherein the transparent structure has an average thickness of about 10 microns to about 2 cm.

3. The transparent structure has in claim 1, wherein the distal end of each protrusion has a diameter substantially less than 0.5 μm.

4. The transparent structure has in claim 1, wherein the distal end of each protrusion has a diameter of about 0.01 μm. to 0.1 μm.

5. The transparent structure has in claim 1, wherein the period between each protrusion is selected to minimize optical effect caused by Bragg's Law.

6. The transparent structure has in claim 1, wherein the terminal end of each protrusion has a roll-off angle of about 1 degree to about 10 degrees.

7. The transparent structure has in claim 1, wherein each protrusion has hydrophobic properties.

8. The transparent structure has in claim 1, wherein each protrusion is integral with the base level.

9. The transparent structure has in claim 1, wherein each protrusion is adhered to the base level.

10. A process for producing a surface that is dust resistant comprising:
(a) providing a body with a surface, the surface having a base level,
(b) maintaining said surface at a temperature suitable for processing,
(c) forming protrusions on said substrate extending from said base level; and
(d) said protrusions having a distal end relative said base level with a contact area dimension substantial least than contact area dimension of particle to be acted upon.

11. A process for producing a surface that is dust resistant comprising:
(a) providing a glass with a surface, the surface having a base level,
(b) maintaining said glass surface at a temperature suitable to keep said glass in a continuous or segmented molten state,
(c) forming protrusions on said glass surface while in molten state; and
(d) said protrusions having a distal end relative to said base level with a contact area dimension substantial least than contact area dimension of particle to be acted upon.

12-14. (canceled)

15. The method as in claim 11, wherein said forming is by embossing.

16. The method as in claim 11, wherein said forming is by stamping.

17. The method as in claim 11, wherein said forming is by using nozzles.
